(19) United States
(12) Patent Application Publication
(10) Pub. No.: US 2019/0291407 A1
(43) Pub. Date: Sep. 26, 2019

(54) CUSTOM PRINTING OF CUPS, GLASSES, AND OTHER VESSELS

(71) Applicant: Jet Printers L.L.C., Larence, KS (US)

(72) Inventor: James Schwartzburg, Lawrence, KS (US)

(73) Assignee: Jet Printers L.L.C., Lawrence, KS (US)

(21) Appl. No.: 16/289,193

(22) Filed: Feb. 28, 2019

Related U.S. Application Data
(60) Provisional application No. 62/636,686, filed on Feb. 28, 2018.

(51) Int. Cl. B41F 17/28; B41F 17/18

(52) U.S. Cl. CPC B41F 17/28; B41F 17/002; B41F 17/18

(57) ABSTRACT

A system for printing on containers or vessels, such as plastic cups, may use one or more inkjet printer head to produce an image on the exterior of a vessel. A planar digital image may be transposed to a surface corresponding to the surface of a vessel being printed upon. A dial driven by an indexer may bear a plurality of mandrels through stations within the system to print, cure, and process images and/or the vessel surface. Each mandrel may receive a vessel and then transport the vessel to at least one printing station and at least one curing station before the vessel is removed from the mandrel.

### CROSS-REFERENCE TO RELATED APPLICATIONS

This application claims priority to U.S. Provisional Patent Application No. 62/636,686, filed on Feb. 28, 2018 and entitled “CUSTOM PRINTING OF CUPS, GLASSES, AND OTHER VESSELS,” which is incorporated herein by reference.

### FIELD OF INVENTION

The present invention relates to printing on containers or vessels. More particularly, the present invention relates to systems and methods for printing digital images and/or text on containers such as cups and glasses.

### BACKGROUND AND DESCRIPTION OF THE RELATED ART

Customized cups, glasses, and other vessels may be desired in a variety of circumstances. For example, weddings, parties, and other gatherings may benefit from glasses or other vessels printed with words, logos, photos, or other insignia commemorating the occasion. While customized cups, glasses, and other vessels have long been available to those able to pay for the large cost of preparing them, even as printing technology has largely automated the customization process, the cost of customizing items such as cups through printing has continued to make such customization impractical for those with small numbers needed or less than large budgets. Due to the size and complexity of printers capable of applying ink to cups and other items, preparing such customized items has been unreasonably expensive for most individuals, groups, and events.

### SUMMARY OF THE INVENTION

The present invention may provide systems and methods for printing upon vessels, such as plastic cups or glasses, in order to create useful items bearing desired commemorative images, letters, logo, insignia, etc. By providing an inexpensive, compact, and easy to operate the system for preparing such customized vessels, customized cups, etc., may be widely used for even small occasions or those on a limited budget. Further, by providing a system small enough to be installed, maintained, and operated in a wide variety of commercial locations, the printing may be performed more conveniently and quickly than is possible if the print order must be sent to another location for execution. While in the past mechanized printing of vessels required the use of offset printing, with its inherent expensive setup and configuration making such an approach economical for only large production runs, systems and methods in accordance with the present invention use inkjet printing technology to apply ink to vessels such as cups or glasses.

In some examples, the present invention may comprise systems that provide at least one printer mechanism, such as an inkjet printer head and associated servos, electronics, and other devices to actuate and position the print head and to control its operation as part of the printing process. In further examples, a curing station may use ultraviolet light to set the ink applied by an inkjet printer head. In yet further examples, multiple inkjet printer heads may be provided, with curing stations provided to set the ink after application by each of the inkjet printer heads. An indexing system, such as a roller cam indexer, may rotate a dial or turntable to move a cup from one station to another in systems in accordance with the present invention. A dial or turntable may be driven by such an indexer, with cups or other vessels born on mandrels or similar devices affixed to the dial and extending from a face of the dial or turntable.

A system in accordance with the present invention may receive cups having known dimensions into a feeder. The feeder may place individual cups upon mandrels that retain the cup in a desired orientation and move the cup to a desired location for printing, curing, or other processing. Any number of mandrels may be used to receive, retain, and position cups for printing. In some examples herein eight mandrels are depicted, while in further examples twelve mandrels are depicted, but any number of mandrels may be used in systems and methods in accordance with the present invention. A mandrel may rotate to present a desired portion of the surface of the cup to a printer head. In some examples, a mandrel bearing a cup for printing may rotate at a known and/or measured rate, permitting a jet printing head to apply ink to a desired portion of the surface of a cup as the rotating mandrel presents that portion of the cup to the print head. The rotation of a mandrel to spin a cup for printing may be powered using a motor or other energy source. A register, such as a magnetic register, may be used to coordinate the operation of a print head with the rotation of a mandrel and cup. Such a register may be provided in each mandrel or in the system that drives the rotation of the mandrel.

In some examples, printing may be performed by an inkjet print head oriented at an angle to align the printer head with the exterior face of the cup to be printed. One or more mandrel may be carried upon a turntable that positions each mandrel at a position to receive cups for printing, with the turntable rotating to carry a cup to the printing mechanism for processing, and the turntable then rotating further to carry a mandrel bearing a printed cup to a removal device. Any number of mandrels may be provided to receive, carry, and orient cups. After an inkjet print head applies ink to a cup, the rotation of the mandrel bearing the cup may present the freshly printed ink on the cup to a curing system, such as a light emitting diode (LED) emitting ultraviolet light, to at least partially cure the ink before the surface bearing the ink is presented to the print head again due to the rotation of the mandrel. As a cup rotates upon a mandrel at a printer station, multiple iterations of printing and curing may be performed until an image having a desired resolution and size has been created.

In some examples, a system in accordance with the present invention may orient a dial or turntable in the vertical plane, such that the turntable may rotate about a horizontal axis through the center of the turntable. In such an example, each mandrel may protrude from a front face of the turntable. The mandrel(s) may extend perpendicular from the front face of the turntable, such that the axis of each mandrel is parallel to the horizontal axis about which the turntable rotates. Each mandrel may provide tapered sides, such as in a truncated cone, to firmly receive vessels having the corresponding interior size, shape, and dimensions upon the mandrel.

### BRIEF DESCRIPTION OF THE SEVERAL VIEWS OF THE DRAWINGS

Examples of systems and methods in accordance with the present invention are described in conjunction with the attached drawings, wherein:

FIG. 1 illustrates a perspective view of an exemplary system in accordance with the present invention;

FIG. 2 illustrates a further perspective view of an exemplary system in accordance with the present invention;

FIG. 3 illustrates a planar view of an exemplary system in accordance with the present invention;

FIG. 4 illustrates a side view of an exemplary system in accordance with the present invention;

FIG. 5 illustrates a rear perspective view of an exemplary system in accordance with the present invention;

FIG. 6 illustrates a further rear perspective view of an exemplary system in accordance with the present invention;

FIG. 7 illustrates a further side view of an exemplary system in accordance with the present invention;

FIG. 8 illustrates a top view of an exemplary system in accordance with the present invention;

FIG. 9 illustrates an example of a printing and curing tandem that may be used in accordance with the present invention;

FIG. 10 illustrates an exemplary method in accordance with the present invention;

FIG. 11 illustrates an exemplary method in accordance with the present invention;

FIG. 12 illustrates an example of an eight mandrel system in accordance with the present invention; and

FIG. 13 illustrates an example of a twelve mandrel system in accordance with the present invention.

### DETAILED DESCRIPTION

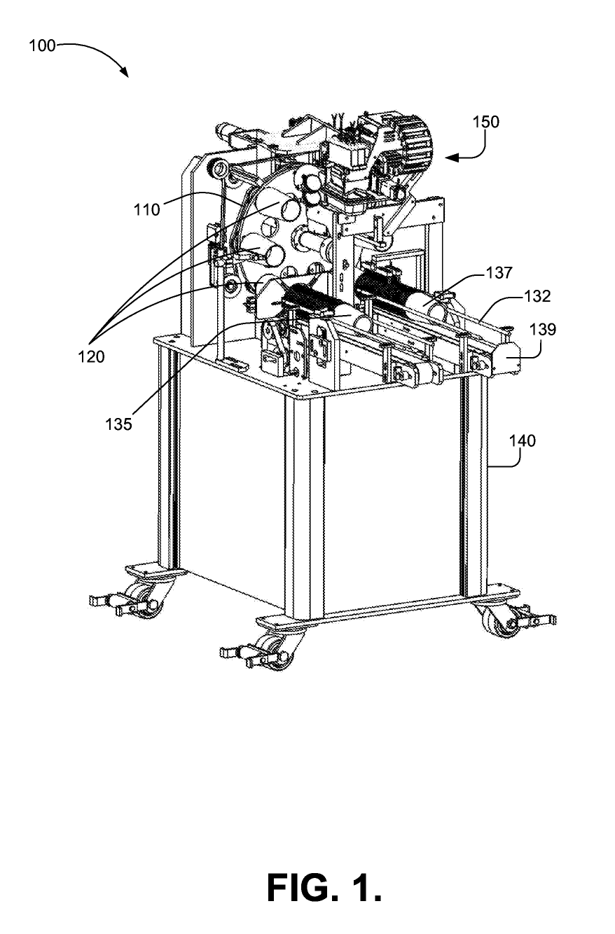

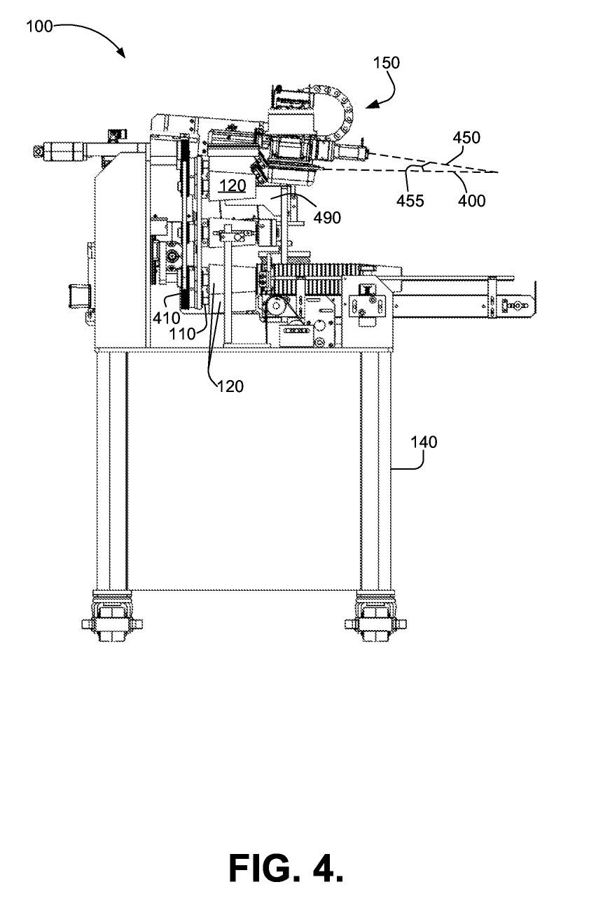

FIG. 1 depicts a perspective view of one exemplary system 100 in accordance with the present invention. An indexer (illustrated in FIG. 4 as indexer 410) may drive a dial or turntable 110 bearing a plurality of mandrels 120. Indexer 410 may rotate dial 110 desired increments to pause for processing by equipment and/or devices positioned at locations around the system 100. Indexer 410 may be a roller cam indexer. Indexer 410 may cause dial 110 to pause at specific angular locations corresponding to the positioning of equipment, such as a print head, within system 100. The angular locations at which dial 110 pauses under the control of indexer 410 may vary based on the distribution of processing stations, the size of the system 100, and/or the number of mandrels 120 provided. While the plurality of mandrels 120 are described in examples herein as comprising eight or twelve mandrels, more or fewer mandrels 120 may be used in accordance with the present invention. Mandrels 120 may be configured to snugly and securely, but detachably, receive and retain a cup for processing by printing a desired design upon all or part of the exterior of the cup. In some examples, a vacuum system integrated into the mandrels may generate suction that will tend to retain a cup upon a mandrel. Each mandrel 120 may bear a cup or other vessel through a plurality of processing stations as the turntable 110 rotates. While dial or turntable 110 is depicted in the example of FIG. 1 having a substantially vertical orientation, other configurations, such as horizontal or at an incline between horizontal and vertical, are possible within the scope of the present invention.

A supply of cups 135 to be printed may be received from a feeder mechanism 130. Feeder mechanism may comprise a continuous stack on an infeed belt. An escapement dispenser may place a single cup upon each mandrel 120 at a single time. Turntable 110 may rotate in a clockwise fashion such that a cup 135, having been received by a mandrel 120, may be rotated to a position proximate to printing mechanism 150. Printing mechanism 150 may provide at least one printer head, such as an inkjet print head, and associated mechanical and electrical systems to activate the print head to deposit ink on a surface. While the dial 110 is described with exemplary clockwise rotation in this example, counter-clockwise rotation may be used without departing from the scope of the present invention.

Printing mechanism 150 may apply ink to the surface of a cup to created desired letters, indicia, photos, images, or other printed materials to the exterior surface of a cup retained upon the mandrel proximate to the printer mechanism 150. Planar digital images may be transposed by systems in accordance with the present invention for application to a surface corresponding to the surface of a cup. As described further below, a curing mechanism, such as an ultraviolet light source, may be provided such that after ink has been applied by the inkjet print head of the printer mechanism 150 the rotation of the cup upon the mandrel will expose the ink deposited to the ultraviolet light to cure or dry the ink before the rotation of the cup upon the mandrel brings the surface of the printed surface of the cup to the print head again. While systems and methods in accordance with the present invention may omit curing at a printing station, at least limited curing or “pinning” as a cup is printed may be used to prevent the application of ink by a print head from blurring or fouling an earlier layer of ink applied. Multiple printing/curing cycles may be performed to produce a desired image upon a cup. In some examples, multiple printing stations may each provide at least one printer mechanism, such as an inkjet print head, to apply ink and a curing station with an ultraviolet light source may be provided after each printer mechanism. In such an example with multiple printing stations and multiple curing stations, different printing stations may apply different ink colors. The use of multiple printing stations may permit a wider range of colors to be applied than would be possible from a single printing station, while the provision of a curing station after ink has been applied and before additional ink has been applied prevents the images being printed from being disturbed by subsequent printing, as well as prevents the fouling of a print head by ink previously deposited. In some examples, a first printing station may create a base layer of pigment upon which one or more subsequent printing stations will create an image. For example, a non-white cup may receive a white background at a first printer station, and that white background may be cured before additional printing stations (and their corresponding curing stations) apply additional colors of ink to form a desired image.

In some examples, some of which are described further herein, additional curing of ink printed on a cup may be provided in additional stations, such as a dedicated curing station that fully cures ink deposited at a preceding printing station. Other types of stations, some of which will be described further in examples below, may provide functions such as surface preparation before printing, additional printing, and/or treating an image after printing and curing.

After the printing of a cup is complete, turntable 110 may rotate to place the cup carried by the next mandrel 120 proximate to printer mechanism 150. As turntable 110 rotates, cups 137 may be removed from their mandrel 120 by a removal mechanism 132. Removal mechanism 132 may provide a stop 139 to prevent finished, printed cups 137 from being dropped. A cabinet 140 may be provided to retain computer processors, computer storage, print supplies, and other materials and/or electronics used in the operation of system 100.

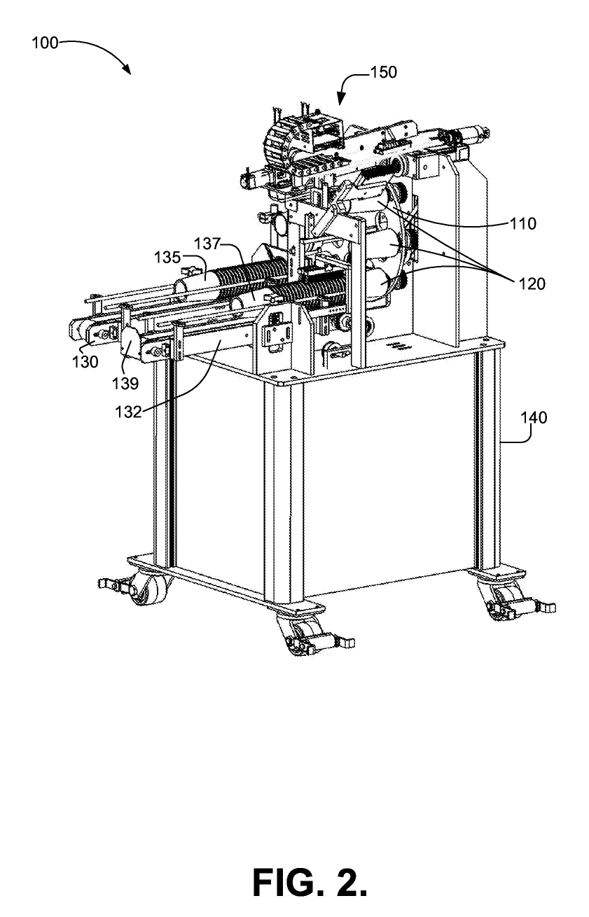

FIG. 2 illustrates a further perspective view of an example printing system 100 in accordance with the present invention for use in applying print to plastic cups or other vessels. As can be seen in FIG. 2, turntable 110 may transport mandrels 120 and any vessel borne by the mandrel 120 from printing mechanism 150 to removal mechanism 132 after the printing of a cup has been completed. It should be further noted that mandrels 120 may rotate at a known and/or measured rate. The rate of rotation may be measured by one or more encoder, such as a magnetic encoder, integrated into a mandrel and/or a system that rotates a mandrel. By coordinating the activation of the printer head(s) within the printing mechanism with the degree of rotation of a cup 135 borne on a mandrel 120, an image may be applied in multiple passes by the printer head(s), and printing may be performed around all or part of the circumference of the outer surface of a cup. In some examples, a rotary encoder may be used to measure the degree of rotation of a mandrel in order to coordinate the application of ink to the surface of a cup borne on the mandrel. For example, a rotary encoder may provide an electronic signal at regular rotational intervals, such as 8,000 equal intervals for 360 degrees of rotation, thereby providing an accurate measure of the portion of the cup presented to a inkjet print head and enabling the appropriate activation of the printer head at the proper time to produce an image. When a cup is symmetric around its exterior, no independent index point for an image is needed other than the location of initial application of ink, thereby simplifying the process of indexing the locations on the surface of a cup as it rotates upon a mandrel. For non-symmetric cups, such as may possess a specific target area for printing image, location indexing may be based upon one or more point along the exterior perimeter of the cup. When multiple printing stations are provided, positional indexing of a cup or the mandrel bearing a cup may be required so that subsequent printing stations may apply ink at the proper locations as the cup and mandrel rotate. In such examples, indexing systems such as electromagnetic indexers incorporated into a mandrel and/or optical indexing systems using indicia printed or provided on the surface of a cup may be used.

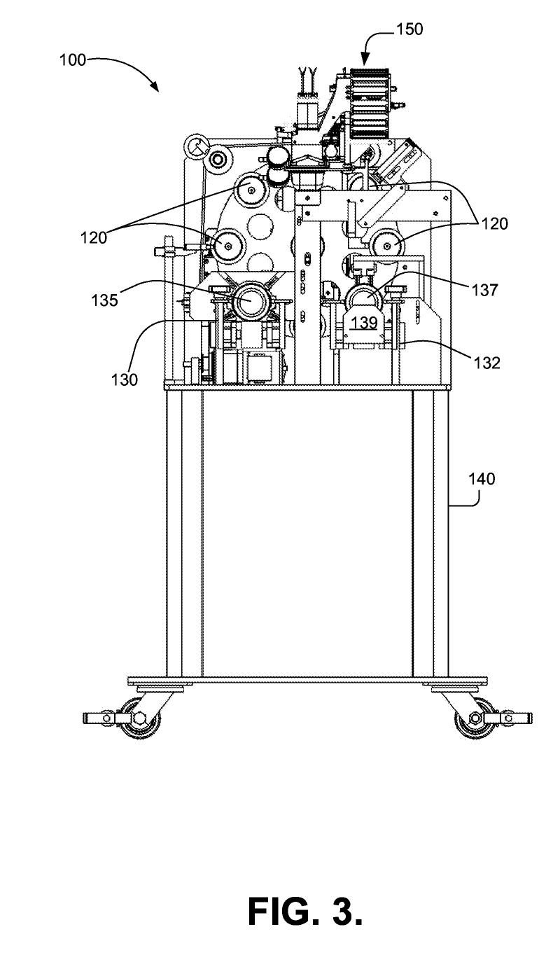

FIG. 3 illustrates a planar view of an exemplary system 100 in accordance with the present invention viewed from the front, i.e. facing the cup feeding mechanism 130 and cup removal mechanism 132. As can be seen in the example of FIG. 3, a plurality of mandrels 120 may protrude from the turntable 110 toward the front of the system 100 and the cup supply mechanism 130 and cup removal mechanism 132.

FIG. 4 depicts a side view of an exemplary system 100 in accordance with the present invention. As can be seen in the example of FIG. 4, an indexer 410 may be provided to rotate turntable 110 to move mandrels bearing cups from the intake mechanism 130 to the printing mechanism 150 and, thereafter, to the cup removal mechanism 132, as well as to other optional additional processing stations that may be provided within system 100. As can be further seen in the exemplary printing mechanism 150 depicted in FIG. 4, various components of the printing mechanism 150, particularly the printer head, may be positioned along an axis 450 oriented at an angle 455 relative to horizontal 400, such that the surface of the printer head may be aligned with the exterior wall of a cup borne on a mandrel 120 for printing. A printing mechanism 150 may provide at least one print head, such as a piezo industrial print heads that may be operated using commercially available drive electronics and configurable software. In some examples, two inkjet print heads may be provided within the printing mechanism 150. In further examples, systems and methods in accordance with the present invention may provide print heads with four color channels. Each of the four colors may be applied based on a single index location to produce a desired image on the surface of a cup. However, the present invention may be implemented with print heads having any number of channels, and, as described in some further examples herein, multiple print heads may be used in a system in accordance with the present invention. A curing station 490 may provide ultraviolet light to cure or dry ink placed upon a cup by a print head. Curing station 490 be located such that the rotation of a mandrel bearing a cup will expose the printed surface of the cup to the ultraviolet light. In some examples, the curing station 490 may use LEDs to provide efficient curing of ink. The rotation of a mandrel may permit repeated application of ink to the surface of a cup followed by a curing of the ink, thereby permitting an image to be built through multiple rotations of the cup.

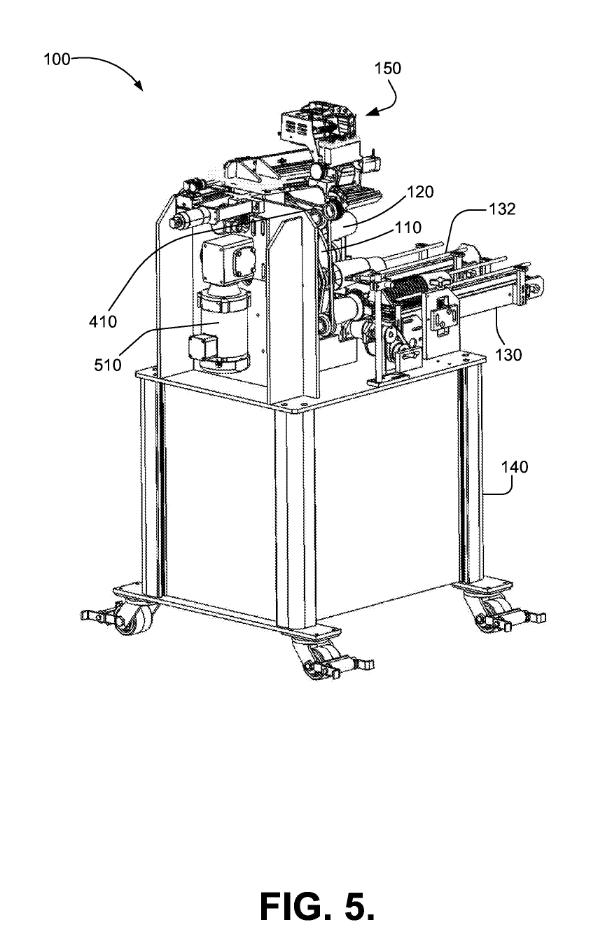

Referring now to FIG. 5, a rear perspective view of an example system 100 in accordance with the present invention is illustrated. A motor 510, such as an electric motor powered by an alternating current, may be provided to power the indexer 410 used to rotate the turntable 110. Motor 510 may further provide power directed to rotate mandrels 120, if desired.

A computer processor operating in accordance with computer readable code embodied in a non-transitory medium may be used to control the operation of printing mechanism 150, motor 510, indexer 410, the rotation of an individual mandrels 120, and/or other aspects of the present invention. Such a computer processor and non-transitory computer readable medium bearing computer readable instructions executed by the computer processor may optionally be retained within cabinet 140, which may optionally be provided as part of system 100. However, systems and methods in accordance with the present invention may utilize computer processors and/or computer readable media provided external to system 100, distributed across system 100 and other computing devices, or otherwise remote from system 100.

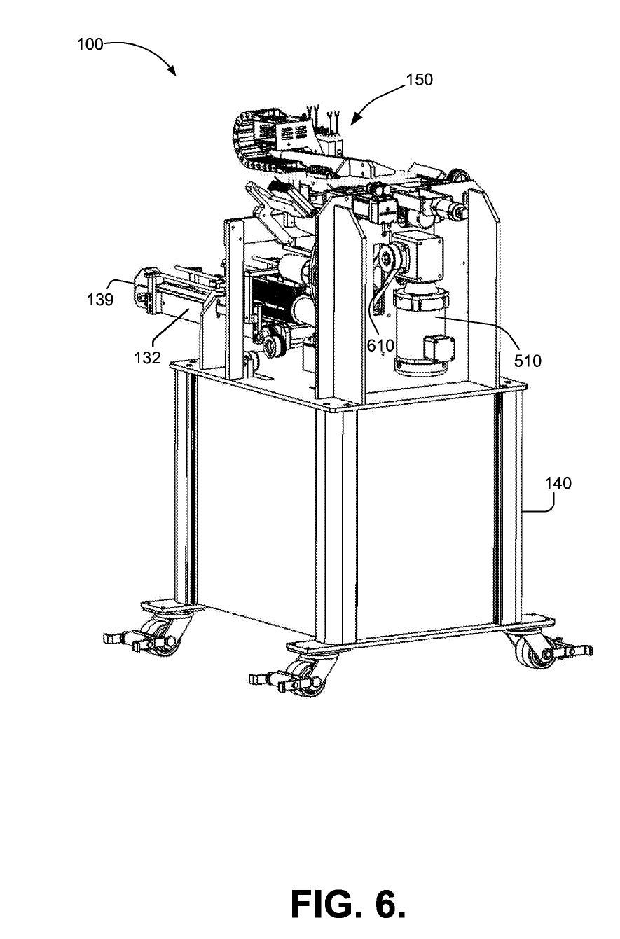

Referring now to FIG. 6, a further rear perspective of an example of a system 100 in accordance with the present invention is illustrated. As can be seen in FIG. 6, a motor 510 may be operably connected to the indexer 410 rotating turntable 110 by a linkage 610. While the exemplary system 100 illustrated in these figures depicts a linkage 610 and indexer 410 using belts and pulleys, other types of linkages and drive mechanisms, such as gears, servos, hydraulics, and/or other devices may be utilized without departing from the scope of the present invention.

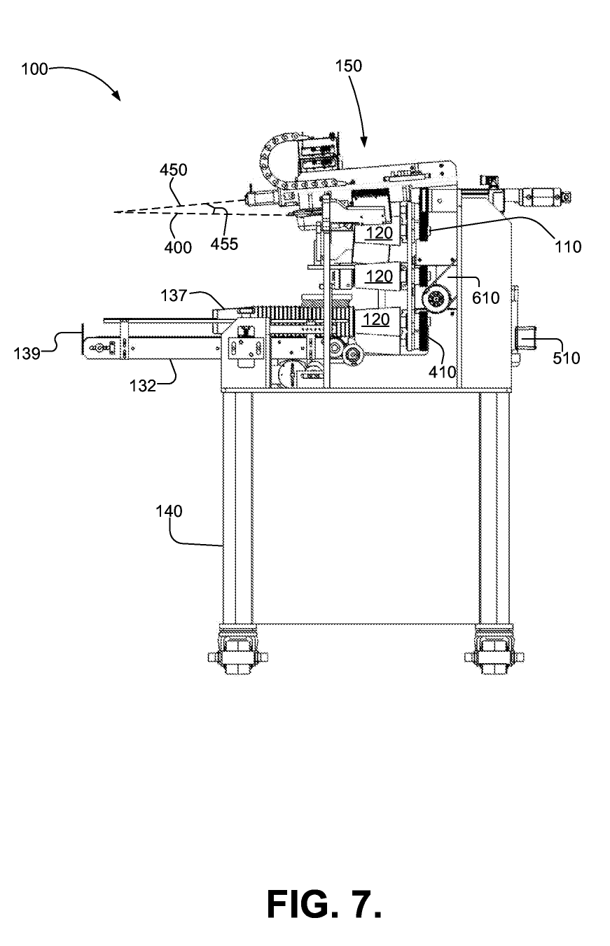

FIG. 7 depicts a further side view of an exemplary system 100 in accordance with the present invention. As can be seen in the example of FIG. 7, linkage mechanism 610 may extend from the motor 510 at the rear of the system 100 to power the rotation of turntable 110 during use of the system 100.

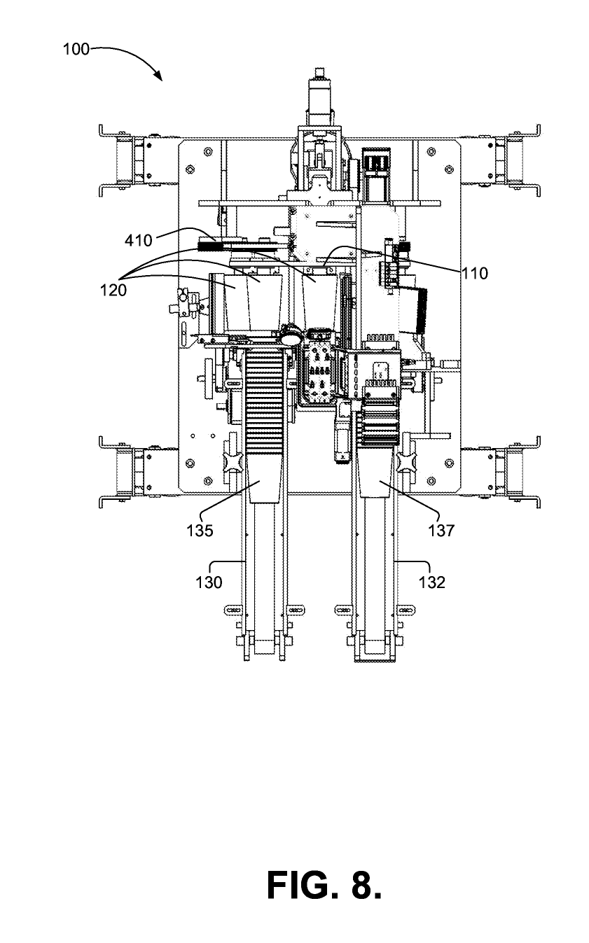

FIG. 8 depicts a top view of an example system 100 in accordance with the present invention. As can be seen in FIG. 8, a turntable 110 may transfer a plurality of mandrels 110 that may bear cups to be printed through the system 100. After printing, removal mechanism 132 may remove printed cups 137 two permit the emptied mandrel to receive a fresh cup 135 for printing.

Systems and methods in accordance with the present invention may utilize printer control software and techniques to index one or more printer head provided within printer mechanism 150 at a desired index position on the exterior surface of a cup to be printed. As a mandrel rotates a cup at a known and/or measured rate, a printer head may jet ink at a desired location on the surface of the cup as that location is oriented at the desired color channel. The printer head may be oriented at an angle relative to horizontal coinciding with the anticipated angle of the exterior wall of a cup, glass, or other vessel to be printed. By inclining the printer head at an angle corresponding to the surface of the cup to be printed, the printer head may be moved linearly along the surface between all or part of the distance between the bottom and top of the cup. The angle of orientation of a printer head may be adjustable to coincide with a plurality of anticipated angles.

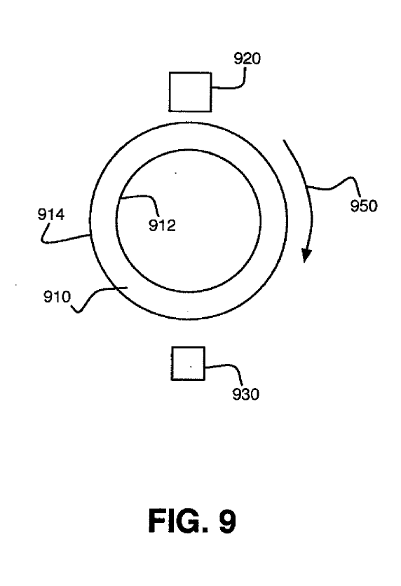

FIG. 9 illustrates one example of how a printer head and a 920 and an ultraviolet light source 930 may operate in tandem as a cup 910 rotates 950 upon a mandrel (not shown in FIG. 9). When multiple printing stations are provided in a system in accordance with the present invention, for example to provide a background on a cup or to permit a wider range of colors to be applied as part of an image, multiple tandems such as illustrated in FIG. 9 may be used. As cup 910 resembles a truncated cone, the base perimeter 912 of the cup 910 is smaller than the top perimeter 914, with the exterior surface of the cup 910 comprising a portion of a conical surface joining the base perimeter 912 to the top perimeter 914. As explained above, in some examples a rotary encoder may enable systems in accordance with the present invention to index an image upon a location on the surface of the cup such that the image may be formed through multiple applications of ink by one or more print head 920. Print head 920 may apply ink at a desired point in the rotation 950 of cup 910, and rotation 950 of cup may expose the recently printed ink to ultraviolet light emitted by source 930, thereby curing the ink before the rotation of the cup 910 brings the applied ink back to the at least one print head 920. Print head 920 may comprise a jet print head with multiple color channels, such as two-color channels or four-color channels. In practice, different color channels of a single print head will be spatially separated by a known distance, which may be accounted for in controlling the operation of the print head 920 to apply ink. In some examples, ink may be pre-heated to facilitate its application by the print head 920. Further, multiple print heads 920 may be provided. For example, two print heads each having two color channels may be provided, with each print head oriented at an angle relative to the other to engage the surface of the rotating cup.

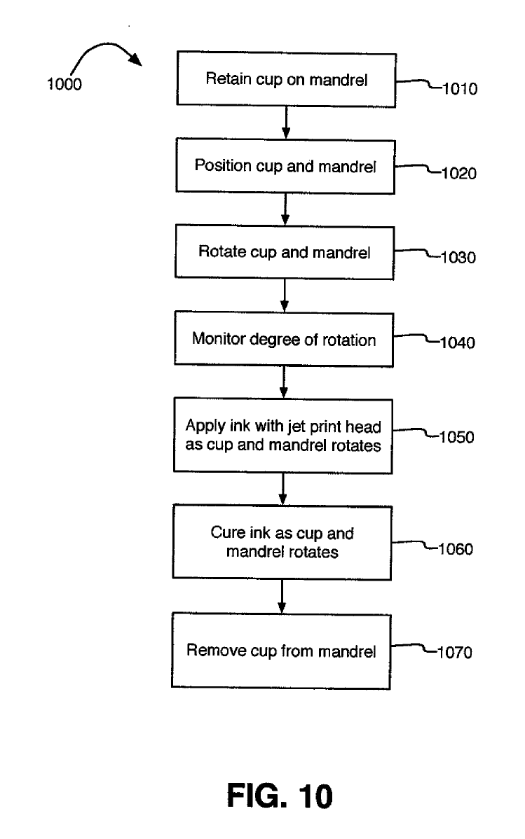

FIG. 10 illustrates an exemplary method 1000 for printing images on cups or other vessels in accordance with the present invention. Method 1000 may receive a planar image for printing and geometrically convert and/or scale the image for printing on the truncated cone surface of the cup or other vessel. The image received by method 1000 may be a digital image. While in some examples an image may be prepared and/or received in a form appropriate for direct application to a conical surface, in many examples a transformation or transposition may be used to create a pleasing image upon the conical surface by adjusting the resolution, proportion, and other properties of the image along the conical surface. In order to obtain an image of a desired quality on the conical surface of a cup or other vessel, all or parts of method 1000 may be performed iteratively.

In step 1010 a cup (or other vessel) may be retained on a mandrel. The mandrel may be affixed to a turntable or other device that permits the mandrel to receive a cup at a first location, present the cup for printing at a second location, and position the cup for removal at a third location. In step 1020, the mandrel may be positioned at the second location for printing. In step 1030 the cup and mandrel may be rotated at a known and/or measured rate. Rotation step 1030 may occur before, during or after positioning step 1020. In step 1040, the rotation of the cup and mandrel may be monitored to provide indexing information for forming an image on the surface of the cup. Monitoring step 1040 may use a rotary encoder or other device to provide a signal as the mandrel rotates a known amount, thereby permitting the total rotation of the cup borne upon the mandrel to be known. In other examples, the rate of rotation of the mandrel may be precisely known or controlled, thereby permitting the amount of rotation to be monitored as a function of time. In step 1050 ink may be applied to the surface of the cup by an inkjet print head as the mandrel rotates the cup. Printing step 1050 may be controlled by a computer processor executing computer readable code retained in a non-transitory form to activate an appropriate color channel of the print head when the appropriate portion of the cup (as determined through the monitoring performed in conjunction with step 1040 and the digital image to be applied) is presented to the print head. In step 1060 the applied ink may be cured using, for example, ultraviolet light produced by a source such as one or more LED. Printing step 1050 and curing step 1060 may be performed repeatedly while a cup and mandrel rotates in accordance with rotation step 1030 and monitoring step 1040. For example, the same area of a cup's surface may be printed repeatedly to obtain a desired resolution, such as 600 dpi, and multiple portions of a cup may have imaged printed upon them. Printing step 1050 and curing step 1060 may be performed multiple times at a single station, but in other examples printing step 1050 and curing step 1060 may be performed at different stations as a turntable transports a cup on a mandrel through a system in accordance with the present invention. After the printing of all images on a cup has been completed, method 1000 may proceed to step 1070 to remove the printed cup from mandrel. In order to perform step 1070, the mandrel bearing the cup may be moved to a third position, which may cause a different mandrel bearing a different cup to be moved to the second position for printing, and which may further cause yet another mandrel to be moved to the first position to receive a cup.

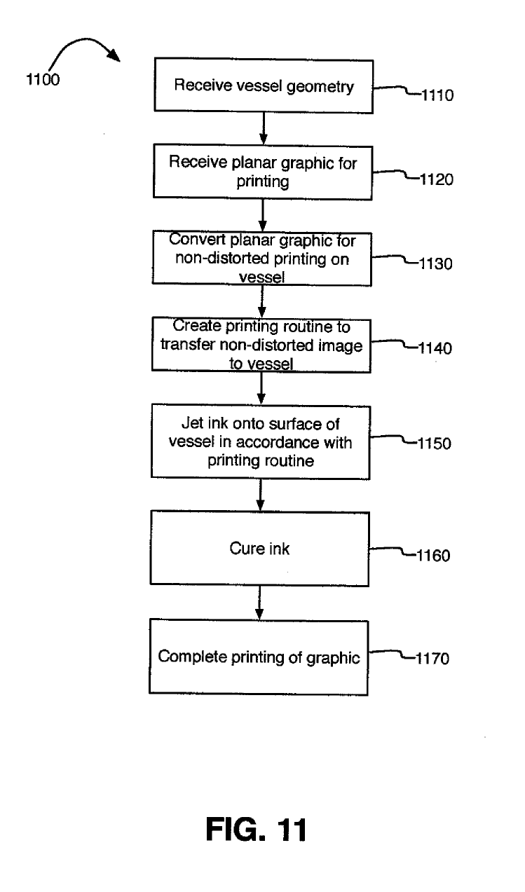

FIG. 11 illustrates a further example of a method 1100 in accordance with the present invention for printing on vessels, such as cups. Method 1100 may begin with receiving a vessel geometry. A vessel geometry may be used to define the surface of the vessel that will be printed upon, such as a truncated cone or other shape. In step 1120 a planar graphic, such as a photo, logo, art, text, or other image may be received. The graphic received in step 1120 may comprise a digital file, but in some examples step 1120 may convert an analog or physical image into a digital representation. In step 1130 the planar graphic may be converted for non-distorted printing on the vessel by transforming the image from a planar image to an image conforming to the vessel geometry received in step 1110. Step 1130 may involve omitting some pixels from an image area or otherwise adjusting the digital planar image for application to the vessel surface. In step 1140 a printing routine to transfer the non-distorted image may be created. The printing routine created in step 1140 may apply ink in multiple passes over the vessel surface as the vessel moves relative to the print head executing the printing routine, for example as the vessel is spun on a mandrel. In step 1150 ink may be jetted onto the surface of the vessel in accordance with the printing routine. Step 1150 may involve a mandrel spinning the vessel while the print head applies various colors of ink to the moving surface of the vessel. Step 1150 may involve coordinating the application of ink with the rotation of the vessel, such as may be made possible using an encoder that measures the degree of rotation of the mandrel bearing the vessel (or the degree of rotation of a structure that drives the rotation of the mandrel. The ink may be cured in step 1160. In some examples ink may be cured in step 1160 using an ultraviolet light source. Step 1160 may be performed in conjunction with step 1150 (for example, by illuminating one side of a rotating vessel with ultraviolet light while the print head applies ink to the other side of the rotating cup), but step 1160 may alternatively or additionally be performed after ink has been applied in step 1150. In step 1170 the printing of the graphic may be completed by performing any final processing to prepare the vessel with the printed graphic for use.

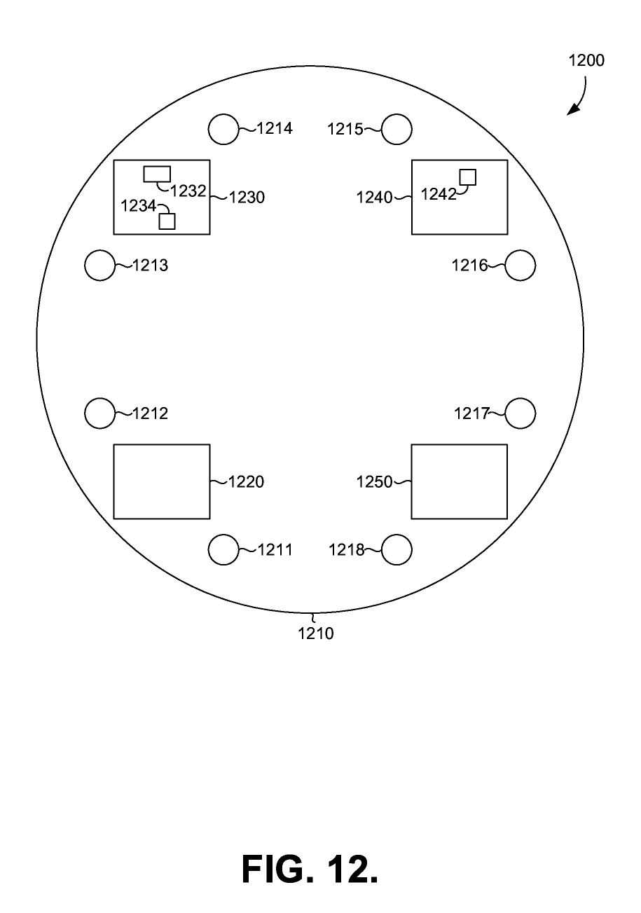

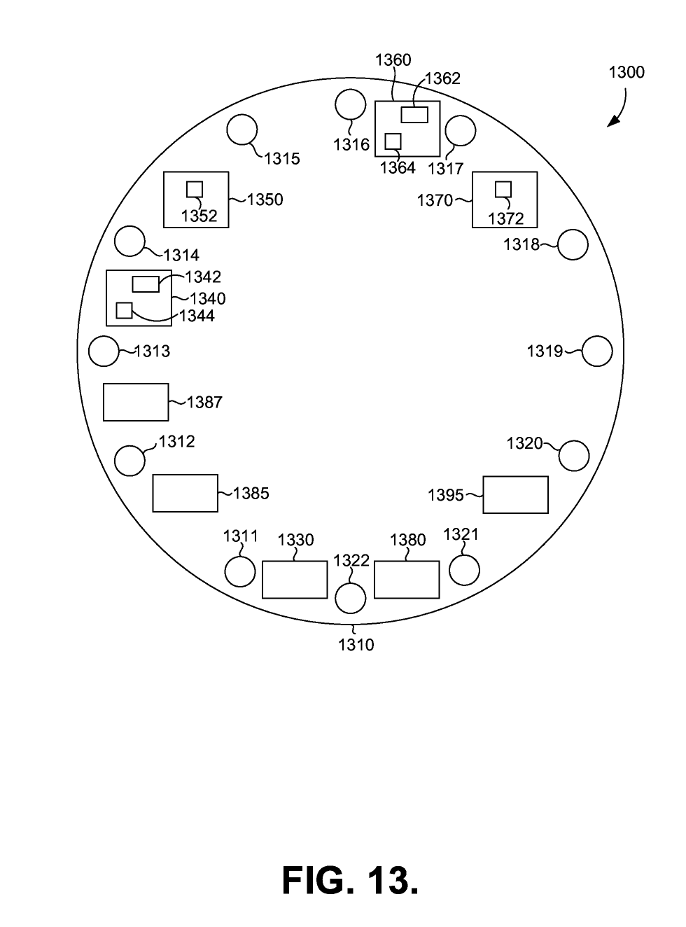

Systems and methods in accordance with the present invention are not limited to any number of mandrels or other retaining devices that may be used to carry cups or other vessels for printing, and similarly systems and methods in accordance are not limited to the use of any specific number or types of stations for processing the surface of a cup or other vessel in accordance with the present invention. The ideal number of mandrels and/or processing stations may vary based upon the size of the vessels to be processed, the space and budget available for a system in accordance with the present invention, the detail and/or type of image to be printed, and other parameters. Two potential examples of systems in accordance with the present invention in this regard are illustrated in FIGS. 12 and 13, but these illustrations are exemplary only.

As depicted in the example of FIG. 12, eight mandrels or other supports may be used to carry cups or other vessels for printing in a system 1200 in accordance with the present invention. As depicted in the example of FIG. 12, a turntable 1210 may provide a first mandrel 1211, a second mandrel 1212, a third mandrel 1213, a fourth mandrel 1214, a fifth mandrel 1215, a sixth mandrel 1216, a seventh mandrel 1217, and an eighth mandrel 1218. Turntable 1210 may bear the mandrels in either a clockwise or counterclockwise fashion through a plurality of stations that perform operations on the surface of the cups or other vessels borne on the mandrels. The example of FIG. 12 illustrates an instance where a clockwise rotating dial 1210 is moving mandrels between stations. When turntable or dial 1210 continues rotation to bring mandrel and a cup borne by the mandrel to a station, an indexer driving the dial 1210 will cause the dial 1210 to pause while the cup is processed at a given station. As noted in some examples herein, a mandrel may be spun or rotated at some stations to facilitate processing such as printing, curing, etc. Mandrels may receive a cup at a loading station 1220. Thereafter the rotation of turntable 1210 may bring a mandrel and the cup it bears to printing station 1230 where the cup is rotated on the mandrel while an inkjet print head 1232 at the printing station 1230 applies ink to the surface of the cup under the control of a computing system executing methods in accordance with the present invention. Printing station 1230 may optionally provide an ultraviolet light source 1234 that may illuminate the surface of the cup to at least partially cure the ink applied by the print head 1232 and to prevent the applied ink from being disfigured or disturbed by the subsequent application of an additional layer of ink by the print head 1232. After printing station 1230 has applied ink to a cup borne by a mandrel, the turntable 1210 may move the mandrel and cup to a curing station 1240 that uses an ultraviolet light source 1242 to finish curing the ink applied to the surface of the cup. Finally, the turntable 1210 may transport a cup to an unloading station 1250 that removes a cup from the mandrel and retains it for further processing or use. While the operations performed at stations described in the examples herein are printing on the surface of a cup, curing the ink placed on the surface of a cup, affixing a cup upon a mandrel, and/or removing a cup from a mandrel, other operations may be performed at stations, such as treating or preparing the surface of a cup to receive ink and/or using a camera or other scanning device to measure or detect the efficacy of other processes performed on the surface of the cup.

FIG. 13 depicts a further example of a system 1300 in accordance with the present invention that uses twelve mandrels or other supports to carry cups or other vessels for printing. As depicted in the example of FIG. 13, a dial or turntable 1310 driven by an indexer may provide a first mandrel 1311, a second mandrel 1312, a third mandrel 1313, a fourth mandrel 1314, a fifth mandrel 1315, a sixth mandrel 1316, a seventh mandrel 1317, an eighth mandrel 1318, a ninth mandrel 1319, a tenth mandrel 1320, an eleventh mandrel 1321, and a twelfth mandrel 1322. Turntable 1310 may bear the mandrels in either a clockwise or counterclockwise fashion through a plurality of stations that perform operations on the surface of the cups or other vessels borne on the mandrels. The example of FIG. 13 shows an instance where turntable 1310 is rotating between stations that may process cups borne on the mandrels. As explained in some examples herein, turntable or dial 1310 may be driven by an indexer that moves dial 1310 between stations and pauses while mandrels are at various stations to allow processing by that station. Mandrels receive a cup at a loading station 1330. Thereafter the rotation of turntable 1310 may bring a mandrel and the cup it bears to first printing station 1340 where the cup is rotated on the mandrel while an inkjet print head 1342 at the printing station 1340 applies ink to the surface of the cup under the control of a computing system executing methods in accordance with the present invention. First printing station 1340 may optionally provide an ultraviolet light source 1344 that may illuminate the surface of the cup to at least partially cure the ink applied by the print head 1242 and to prevent the applied ink from being disfigured or disturbed by the subsequent application of an additional layer of ink by the print head 1342. After first printing station 1340 has applied ink to a cup borne by a mandrel, the turntable 1310 may move the mandrel and cup to a first curing station 1350 that uses an ultraviolet light source 1352 to finish curing the ink applied to the surface of the cup. After first curing station 1350 turntable 1310 may bring cup to a second printing station 1360, where an inkjet print head 1362 may apply further ink to the surface of a cup and where may an ultraviolet light source 1364 may illuminate the surface of the cup to at least partially cure the ink applied by the print head 1362 to prevent the applied ink from being disfigured or disturbed by the subsequent application of an additional layer of ink by the print head 1362. After second printing station 1360 has applied ink to a cup borne by a mandrel, the turntable 1310 may move the mandrel and cup to a second curing station 1370 that uses an ultraviolet light source 1372 to finish curing the ink applied to the surface of the cup at the second printing station 1360. After the second curing station 1230, the rotation of turntable 1310 may bring a cup to an unloading station 1380 that removes a cup from the mandrel and retains it for further processing or use. While the operations performed at stations described in the examples herein are printing on the surface of a cup, curing the ink placed on the surface of a cup, affixing a cup upon a mandrel, and/or removing a cup from a mandrel, other operations may be performed at stations, such as treating or preparing the surface of a cup to receive ink and/or using a camera or other scanning device to measure or detect the efficacy of other processes performed on the surface of the cup.

Still referring to the example of FIG. 13, a first preparation station 1385 and/or a second preparation station 1387 may prepare the surface of a cup for printing before the indexer moves the dial 1310 to position the cup at the first printing station 1340. While described with a first preparation station 1385 and a second preparation station 1387, more preparation stations than two, a single preparation station, or no preparation stations at all may be used in accordance with the present invention. In one example, a first preparation station 1385 may clean or otherwise prepare the surface of a cup using abrasion, oxidation, chemicals, heat, or other processes. For example, a flame (fueled with natural gas, propane, or other fuels) or an electrical discharge may be used to oxidize the surface of the cup to remove dirt, debris, residue from manufacturing or processing the cup, or other material that could interfere with the adhesion of ink to the surface of the cup. In one example, second preparation station 1387 may comprise an ionizer that removes static electric charges from a cup, as static electric charges on a plastic cup may complicate processing and/or interfere with desired ink adhesion. However, if used at all, preparation stations need not be limited to these examples. For example, preparation stations may additionally or alternatively apply material to prime or otherwise prepare the surface of the cup, for example to prevent the later applied inks or other substances from migrating into the material of the cup.

Still referring to FIG. 13, a finalization station 1395 may perform a final treatment to a cup after printing and curing has concluded at the stations described above. Finalization station 1395 may, for example, apply a protective coat to the surface of the cup to prevent the degradation, a coat such as a varnish to increase the shine or luster of the surface, or other treatments to alter the appearance and/or physical attributes of the image(s) printed on the cup or any portion of a cup that did not receive a printed image. Alternatively or additionally, a finalization station 1395 may affix final adornments, further clean a cup, or otherwise perform the final processing of a cup prior to the removal of a cup from a mandrel by an unloading station 1380.

While examples of a preparation station and a finalization station are described in examples of systems in accordance with the present invention in conjunction with the twelve mandrel example of FIG. 13, such stations may be used in conjunction with an eight mandrel system in accordance with the present invention or other systems in accordance with the present invention with more or fewer mandrels than described herein.

Printing an image on a non-planar surface can require geometric or other mathematical manipulation when the original image was prepared or created for a planar surface. For example, a typical logo or photograph may be a two-dimensional image suitable for printing on a sheet of paper, display on a flat screen, or other display on a planar medium. Producing such an image on a curving surface of a vessel in accordance with the present invention may be improved using systems and techniques to accommodate the non-planar surface receiving the image. For example, a cup such as illustrated in some examples herein may possess a surface corresponding to the surface of a truncated right cone. Directly printing a planar image onto such a conical surface will be problematic, both because the print head will only contact a portion of the surface due to the surface's curvature and because the conical nature of the surface receiving the image (i.e., the cup is broader at the top than at the bottom), will cause the image to be distorted if it is not modified.

An image may be converted from a form suitable for printing on a planar surface to a form suitable for printing on the surface of a vessel by first geometrically converting the curved surface to a planar surface without stretching or otherwise distorting the surface. This process need not be performed physically, but rather may be performed mathematically, for example using a computing system executing computer readable code to determine how to convert a given vessel shape to an equivalent planar shape. For example, the truncated conical surface of a cup may be converted to a planar surface by cutting the surface from the top to the bottom and “flattening” the resulting surface to an arced rectangle. A mathematical relationship will exist from each point on the resulting “flattened” surface and the original curved surface. By transposing an image as it would be printed on the flattened surface to the curved surface, distortion may be avoided. For example, the resolution of printing needed may be varied based upon the width of the “cone” where a portion of the image is printed. As a result, a portion of an image on the lower (and narrower) portion of a cup may be printed with a higher resolution than a portion of the image printed on the upper (and thicker) portion of a cup. Further, by accounting for the known curvature of the surface and the geometry of the one or more printer head that will be used to apply the ink to form an image, the printer head may be manipulated relative to the curved surface to provide a desired degree of proximity between the printer head and the surface of the vessel. One example of a system that may be used to convert planar images to images suitable for printing on the surface of a vessel is the Atlas® User Interface and Machine Control available from Global Inkjet Systems Ltd, Edinburgh House, St. John's Innovation Park, Cowley Road, Cambridge, in the United Kingdom.

In further examples of systems and methods in accordance with the present invention, glasses, cups, bowls, and/or a variety of vessels may be printed for customization. In some examples, mandrels may be detachably affixed to a turntable, permitting mandrels to be removed and replaced by mandrels corresponding to different types of vessels or vessels of different sizes. In some examples, a cup or other vessel may be rotated by the mandrel at the printer mechanism in order to permit all or part of the outer circumference of the cup to be printed. In other examples, physical mechanisms may rotate the cup or other vessel upon the mandrel in order to orient the cup relative to the printer head as desired. In yet further examples, the mandrel may hold a cup in a fixed orientation while a printer mechanism may rotate around the circumference of all or part of a cup.

Systems and methods in accordance with the present invention may rotate a cup upon a mandrel for printing at a rotational rate corresponding to the print head jetting frequency of the at least one print head used to jet ink onto the surface of the cup. Jet print heads may produce superior print quality when fired at intervals corresponding to a jetting frequency. While different jet print heads may possess different jetting frequencies due to their different constructions and configurations, one example of a jetting frequency is 20 kHz. My at least approximately matching the rotational rate of a mandrel with the jetting frequency of a print head, such as within 500 Hz of the jetting frequency, the printing of images upon the surface of the cup may be facilitated.

In operation, systems and methods in accordance with the present invention may be operated, at least in part, by one or more computing devices operating to execute computer readable code retained in a non-transitory format. Different computing devices may control different parts of the systems and/or methods in accordance with the present invention, although a single computing device may control all aspects of systems and methods in accordance with the present invention. Inputs used by computing devices to print images on cups or other vessels in accordance with the present invention may be provided by human operators, sensors, encoders, etc. For example, systems in accordance with the present invention may receive an image to be printed, signals (such as from a rotary encoder) to provide information regarding the orientation of a mandrel bearing a cup or other vessel, an indication of the location of one or more mandrel within the system (such as at a first position to receive a cup, a second position to print a cup, or a third position to remove a cup), a signal to begin printing once a cup is in position for printing, and/or a print complete signal after all of an image has been printed on a cup.

In the examples described above, a cup may be placed upon a mandrel at a first position within a system, printing may be performed upon a cup at a second location within a system, and a cup may be removed from a mandrel at a third location within the system. However, systems and methods in accordance with the present invention may perform additional operations at additional positions if desired. For example, some materials used for cups (or other vessels to be printed in accordance with the present invention) may benefit from pre-treatment prior to printing to prime or otherwise prepare a surface. By way of further example, after printing protective coatings or other surface treatments may be desired. The present invention is not limited to any particular number of operations performed at any particular location or locations within a system.

While systems and methods in accordance with the present invention may be used to print upon a variety of materials used to form vessels to be customized in accordance with the present invention. For example, materials such as glass, metal, wood, etc. may be used to form cups, glasses, bowls, or other vessels. In many examples, however, cups or other vessels printed upon in accordance with the present invention may be comprised of various types of plastics, thereby providing durable, inexpensive vessels for use by the ultimate end user.

1. A printing system for printing upon vessels, comprising:
a dial having a plurality of mandrels, each of the mandrels having a size and shape corresponding to vessels to be printed upon;
an indexer that rotates the dial having the plurality of mandrels to move the mandrels between a variety of stations;
a mandrel rotational system that rotates each mandrel at a known rate of rotation;
a feeding system that places a vessel for printing onto a mandrel at a first station when the mandrel is positioned at the first station, such that the mandrel may bear the vessel through additional stations;
an inkjet printer head that applies ink to the vessel as the vessel rotates upon the mandrel, the inkjet printer head controlled by a computer processor executing computer readable code to print ink of desired colors at desired locations on the rotating vessel by coordinating the application of ink to the vessel with the measurement of an encoder that measures the degree of rotation of the mandrel bearing the vessel, the inkjet printer head being at a station after the first station as the dial rotates;
a curing station that illuminates a vessel with ultraviolet light to cure the ink deposited by the inkjet printer head, the curing station being after the inkjet printer head as the indexer rotates the dial; and
an unloading station that removes vessels from mandrels, the unloading station being after the inkjet printer head and the curing station as the indexer rotates the dial.

2. The printing system for printing upon vessels of claim 1, the system further comprising:
a second inkjet printer head, the second inkjet printer head at a station after the curing station and before the unloading station as the indexer rotates the dial, the second inkjet printer head controlled by a computer processor executing computer readable code to print ink of desired colors at desired locations of the rotating vessel in coordination with a second encoder that measures the rotation of the mandrel bearing the vessel; and
a second curing station that illuminates the vessel with ultraviolet light to cure the ink deposited by the second inkjet printer head, the second curing station being after the second inkjet printer head and before the unloading station as the indexer rotates the dial.

3. The printing system for printing upon vessels of claim 2, wherein the second inkjet printer head prints ink of different colors than the inkjet printer head.

4. The printing system for printing upon vessels of claim 3, wherein the plurality of mandrels comprises eight mandrels.

5. The printing system for printing upon vessels of claim 3, wherein the plurality of mandrels comprises twelve mandrels.

6. The printing system for printing on vessels of claim 3, wherein the vessels received by the mandrels are plastic cups and each of the plurality of mandrels has a shape and size conforming to the interior of the plastic cups.

7. The printing system for printing on vessels of claim 6, wherein the plastic cups have an exterior shape of a truncated cone.

8. The printing system for printing on vessels of claim 6, wherein the inkjet printer head applies a uniform ink over at least a portion of the cup to provide a background to receive additional ink, and further comprising:
a third inkjet printer head, the third inkjet printer head at a station after the second curing station and before the unloading station as the indexer rotates the dial, the third inkjet printer head controlled by a computer processor executing computer readable code to print ink of desired colors at desired locations of the rotating vessel in coordination with a third encoder that measures the rotation of the mandrel bearing the vessel; and
a third curing station that illuminates a vessel with ultraviolet light to cure the ink deposited by the second inkjet printer head, the third curing station being after the second inkjet printer head and before the unloading station as the indexer rotates the dial.

9. The printing system for printing on vessels of claim 1, wherein the encoder is integrated into the mandrel.

10. The printing system for printing on vessels of claim 1, wherein the encoder is integrated into the mandrel rotation system.

11. The printing system for printing on vessels of claim 10, wherein the mandrel rotation system into which the encoder is integrated comprises a mandrel rotation system that engages the mandrel when the indexer rotates the dial to place the mandrel at the inkjet printer head and disengages the mandrel when the indexer rotates the mandrel away from the inkjet printer head.

12. A system for printing on the exterior of cups, the system comprising:
at least one printing station, the at least one printing station comprising an ultraviolet light source and an inkjet print head under the control of a computing system to print ink on a cup to be printed;
a cup delivery system that moves the cup to be printed to the at least one printing station, the cup delivery system comprising a mandrel that retains the cup to be printed while the mandrel rotates the cup at a known rate of rotation and an encoder that interfaces with the computing system controlling the inkjet print head to enable the computing system to cause the inkjet print head to deposit ink at desired locations on the rotating cup retained by the mandrel;
a cup loading system that places the cup to be printed onto the mandrel of the cup delivery system before the cup delivery system moves the cup to be printed to the at least one printing station; and
a cup unloading system that removes the cup from the mandrel of the cup delivery system after the cup has been printed by the at least one printing station; and
a mandrel rotation system that rotates the mandrel and cup while the mandrel and cup are positioned at the printing station, the mandrel rotation system engaging the mandrel when the mandrel is positioned at the printing station and disengaging from the mandrel when the mandrel is moved from the print station, the mandrel rotation system comprising at least a drive system and an encoder, the encoder interfaced with the computing system controlling the inkjet print head to apply ink to at desired locations on the exterior of the cup as the cup rotates using the encoder to determine what locations of the cup are presented to the inkjet print head,
and wherein the ultraviolet light source emits ultraviolet light that at least partially cures the ink applied by the inkjet print head as the mandrel and cup rotate.

13. The system for printing on the exterior of cups of claim 12, further comprising a curing station, the curing station providing a second ultraviolet light source distinct from the ultraviolet light source of the at least one printing station, the cup delivery system moving the cup to the curing station after the printing station and before the cup unloading station, and wherein the mandrel of the cup delivery system rotates the cup at the curing station to expose the exterior of the cup to the ultraviolet light emitted by the second ultraviolet light source.

14. The system for printing on the exterior of cups of claim 13, wherein the cup delivery system comprises:
a dial that bears a plurality of mandrels; and
an indexer that drives the rotation of the dial to move the mandrels between stations and to pause mandrels at stations for processing.

15. The system for printing on the exterior of cups of claim 14, further comprising an image processing system that receives a planar digital image and transposes the planar digital image to a shape corresponding to the surface of the cup.

16. The system for printing on the exterior of cups of claim 15, wherein the surface corresponding to the surface of the cup comprises a truncated cone.
